(19) United States
(12) Patent Application Publication
(10) Pub. No.: US 2009/0046214 A1
(43) Pub. Date: Feb. 19, 2009

(54) 2D/3D CONVERTIBLE DISPLAY APPARATUS AND METHOD OF DRIVING THE SAME

(75) Inventors: Sang-moo PARK, Uijeongbu-si (KR); Sergey CHESTAK, Suwon-si (KR); Dae-sik KIM, Suwon-si (KR); Jae-phil KOO, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/131,275

(22) Filed: Jun. 2, 2008

(30) Foreign Application Priority Data
Aug. 17, 2007 (KR) 10-2007-0083019

(51) Int. Cl. H04N 13/00; G02F 1/13

(52) U.S. Cl. 349/15

(57) ABSTRACT

A 2D/3D convertible display apparatus and a method of driving the same are provided. The 2D/3D convertible display apparatus includes a liquid crystal display panel, a polarizing panel changing the direction of polarization of an incident light beam according to a signal applied thereto, a panel driver applying a driving signal to the liquid crystal display panel when receiving a vertical synchronization signal and applying a driving signal to the polarizing panel when receiving a stereo synchronization signal, and a synchronization signal generator generating the stereo synchronization signal to allow the panel driver to apply the driving signal to the polarizing panel in both 2D and 3D modes. Accordingly, the driving signal is applied to the polarizing panel in the 2D mode to solve a problem that the polarizing panel is off to cause a defective image to be displayed when the driving signal is not applied to the polarizing panel in the 2D mode.

### CROSS-REFERENCE TO RELATED PATENT APPLICATION

This application claims priority from Korean Patent Application No. 10-2007-0083019, filed on Aug. 17, 2007, in the Korean Intellectual Property Office, the disclosure of which is incorporated herein in its entirety by reference.

### BACKGROUND OF THE INVENTION

1. Field of the Invention

The present invention relates to a 2-dimensional 3-dimensional (2D/3D) image convertible display apparatus and a method of driving the same and, more particularly, to a 2D/3D convertible display apparatus and a method of driving the same for driving a polarizing panel in a 2D mode.

2. Description of the Related Art

In view of the development of technology, image display apparatuses displaying photorealistic images are required. Accordingly, 3D image display apparatuses capable of displaying 3D stereo images are being developed. These 3D image display apparatuses can be applied to the fields of medicine, games, advertising, education and the military, as well as TV systems, to obtain enhanced effects.

A stereo image is obtained according to the principle of stereo vision through two eyes of a person. The most important factor of the stereo effect is binocular parallax caused by a distance between two eyes, which corresponds to approximately 65 mm. Accordingly, if the same image as a real image is seen by two eyes of a person, the stereo effect can be easily obtained. To achieve this, two cameras having the same characteristics are located apart from each other by the distance between the two eyes of a person and take pictures of an object. Then, the picture captured by the left camera is seen by the left eye and the picture captured by the right camera is seen by the right eye.

3D image display apparatuses include a type of display that uses glasses and a type of display that separates left and right images from each other to obtain a 3D image without using glasses. The type of display that uses glasses is divided into a type of display with polarized glasses and a type of display with shutter glasses, and the type of display that uses no glasses is divided into a parallax barrier type display, a lenticular type display, an integral imaging type display and a holography type display.

In a display that uses polarized glasses, left and right binocular signals are alternately input to a 3D liquid crystal display panel for scan lines and an image corresponding to a mixture of the left and right binocular signals passes through a polarization filter attached to the front side of the liquid crystal display panel, which has different polarization characteristics for the left and right binocular signals. An observer can see a 3D image displayed on the display that uses polarized glasses when wearing polarized glasses.

Referring to FIG. 1, a conventional display that uses polarized glasses includes a liquid crystal display panel 100 for displaying images having specific polarized components, a polarizing panel 110 having different polarizing directions for left-eye and right-eye images displayed on the liquid crystal panel 100, and polarized glasses 120 transmitting different polarized beams for a left eye and a right eye. For example, the polarizing panel 110 can be formed by alternately bonding a 0°retarder and a 90°retarder. The polarized glasses 120 include two polarizers 112 and 114 transmitting different polarized beams. That is, a polarizing direction of the left-eye image becomes different from a polarizing direction of the right-eye image according to the polarizing panel 110 and the polarized glasses 120 separate the left-eye image and the right-eye image from each other and respectively transmit the left-eye image and the right-eye image. Accordingly, a viewer can see a 3D image.

A 3D image display apparatus switching between a 2D mode and a 3D mode to selectively provide a 2D image and a 3D image according to an image signal to be displayed is required. Accordingly, a variety of 2D/3D convertible stereo image display apparatuses have been developed. Referring to FIG. 1, the polarizing panel is operated, as described above, in the 3D mode, and thus a viewer can watch a 3D image. In the 2D mode, however, the polarizing panel is not operated and the viewer can watch a 2D image.

A conventional 2D/3D convertible display apparatus uses all pixels of a liquid crystal display panel to display a left-eye image and a right-eye image in a 3D mode, and thus the resolution of the liquid crystal display panel corresponds to the resolution of the left-eye and right-eye images. However, the conventional 2D/3D convertible display apparatus has a low frame rate because the conventional 2D/3D convertible display apparatus requires a single frame for a left-eye image and a single frame for a right-eye frame for a single frame of a 3D image. At a low frame rate, the left-eye image or the right-eye image cannot be immediately changed due to the limit of the response speed of the liquid crystal display panel. This causes cross-talk corresponding to a mixture of the left-eye image and the right-eye image. To solve this problem, a liquid crystal display panel with a high response speed is used. In this case, however, a polarizing panel is off and thus alignment is not accomplished to cause a phenomenon that it seems as if bubbles are dispersed in the polarizing panel.

### SUMMARY OF THE INVENTION

The present invention provides a 2D/3D convertible display apparatus and a method of driving the same for driving a polarizing panel in a 2D mode.

According to an aspect of the present invention, there is provided a 2D/3D convertible display apparatus comprising: a liquid crystal display panel; a polarizing panel changing the direction of polarization of an incident light beam according to a signal applied thereto; a panel driver applying a driving signal to the liquid crystal display panel when receiving a vertical synchronization signal and applying a driving signal to the polarizing panel when receiving a stereo synchronization signal; and a synchronization signal generator generating the stereo synchronization signal to allow the panel driver to apply the driving signal to the polarizing panel in both 2D and 3D modes.

According to another aspect of the present invention, there is provided a 2D/3D convertible display apparatus comprising: a liquid crystal display panel; a polarizing panel changing the direction of polarization of an incident light beam according to a signal applied thereto; and a panel driver simultaneously applying driving signals to the liquid crystal display panel and the polarizing panel when receiving a vertical synchronization signal.

The liquid crystal display panel may be an optically compensated birefringence (OCB) liquid crystal display panel.

The panel driver may comprise a liquid crystal display panel driver outputting a liquid crystal display panel driving signal and a polarizing panel driver outputting a polarizing panel driving signal.

According to another aspect of the present invention, there is provided a method of driving a 2D/3D convertible display apparatus, comprising: receiving a vertical synchronization signal; outputting a liquid crystal display panel driving signal and a polarizing panel driving signal in response to the vertical synchronization signal; and driving a liquid crystal display panel and a polarizing panel according to the liquid crystal display panel driving signal and the polarizing panel driving signal.

According to another aspect of the present invention, there is provided a method of driving a 2D/3D convertible display apparatus, comprising: generating a stereo synchronization signal in both 2D and 3D modes; outputting a polarizing panel driving signal in response to the stereo synchronization signal; and driving a polarizing panel according to the polarizing panel driving signal.

According to the present invention, a driving signal is applied to the polarizing panel in the 2D mode to solve a problem that the polarizing panel is off to cause a defective image to be displayed when the driving signal is not applied to the polarizing panel.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a structure of a conventional 3D display with polarized glasses;

FIG. 2 is a block diagram of a 2D/3D convertible display apparatus according to an exemplary embodiment of the present invention;

FIGS. 3A and 3B are waveform diagrams of a stereo synchronization signal and a polarizing panel driving signal;

FIG. 4 is a block diagram of a 2D/3D convertible display apparatus according to another exemplary embodiment of the present invention;

FIG. 5 is a flow chart of a method of driving a 2D/3D convertible display apparatus according to an exemplary embodiment of the present invention; and

FIG. 6 is a flow chart of a method of driving a 2D/3D convertible display apparatus according to another exemplary embodiment of the present invention.

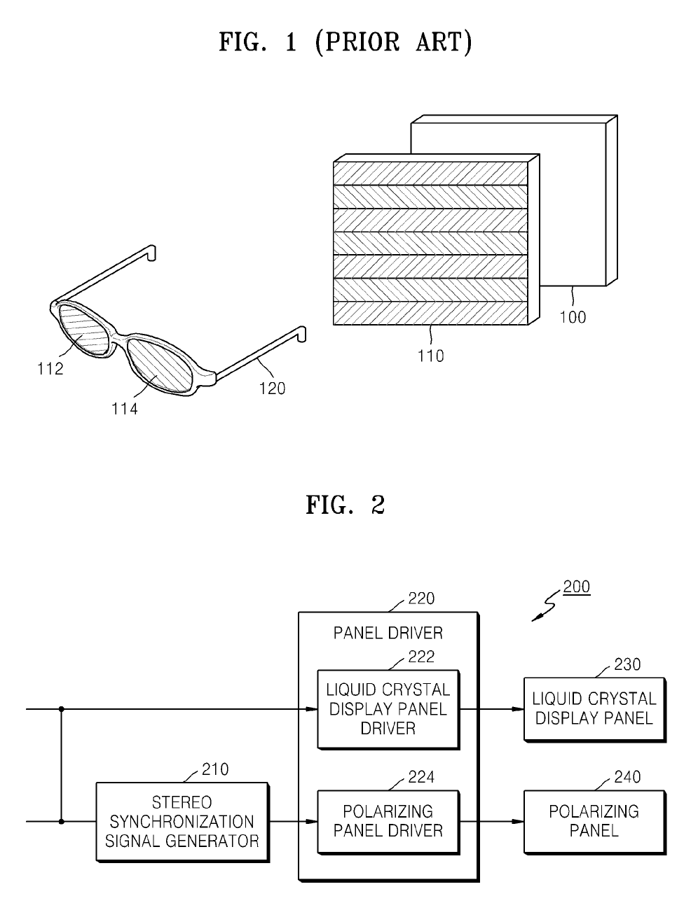

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

FIG. 2 is a block diagram of a 2D/3D convertible display apparatus 200 according to an embodiment of the present invention. Referring to FIG. 2, the 2D/3D convertible display apparatus 200 applies signals for respectively driving a liquid crystal display panel 230 and a polarizing panel 240. The 2D/3D convertible display apparatus 200 includes a stereo synchronization signal generator 210, a panel driver 220, the liquid crystal display panel 230, and the polarizing panel 240. The panel driver 220 includes a liquid crystal display panel driver 222 and a polarizing panel driver 224.

A vertical synchronization signal provided by an external device is input to the liquid crystal display panel driver 222. The liquid crystal display panel driver 222 outputs a liquid crystal display panel driving signal to drive the liquid crystal display panel 230. The stereo synchronization signal generator 210 generates a stereo synchronization signal and applies the stereo synchronization signal to the polarizing panel driver 224. The polarizing panel driver 224 outputs a polarizing panel driving signal to drive the polarizing panel 240. The 2D/3D convertible display apparatus 200 operates in a 2D mode when a 2D image signal is input thereto and operates in a 3D mode when a 3D image signal is applied thereto.

In the 3D mode, the vertical synchronization signal and the 3D image signal are supplied to the 2D/3D convertible display apparatus 200 from an external device. The vertical synchronization signal is input to the liquid crystal display panel driver 222, and the liquid crystal display panel driver 222 outputs the liquid crystal display panel driving signal to drive the liquid crystal display panel 230. The liquid crystal display panel 230 alternately displays a left-eye image and a right-eye image in a time-sharing method. The 2D/3D convertible display apparatus 200 alternately provides a left-eye light beam and a right-eye right beam in synchronization with the left-eye image and the right-eye image displayed on the liquid crystal display panel 230 such that an observer can see a 3D image. Preferably, the liquid crystal display panel 230 corresponds to an optically compensated birefringence (OCB) liquid crystal display panel with a high response speed. However, other liquid crystal display panels can be also used as the liquid crystal display panel 230.

When the 3D image signal is applied to the 2D/3D convertible display apparatus 200, the stereo synchronization generator 210 generates the stereo synchronization signal and provides the stereo synchronization signal to the polarizing panel driver 224. Then, the polarizing panel driver 224 outputs the polarizing panel driving signal to drive the polarizing panel 240. The polarizing panel 240 uses a property that a polarizing direction of a polarizer is changed when a voltage is applied to the polarizer. For example, when a predetermined first voltage is applied to a polarizing panel, the polarizing direction of the polarizing panel is changed to a vertical direction in which a polarizing direction of a right lens of polarized glasses corresponds to the polarizing direction of the polarizing panel, and thus a vertical component image displayed on a liquid crystal display panel is seen by the right eye of an observer. When a predetermined second voltage is applied to the polarizing panel, the polarizing direction of the polarizing panel is changed to a horizontal direction, and thus the observer can see a horizontal component image displayed on the liquid crystal display panel with his left eye through a left lens of the polarized glasses having a horizontal polarizing direction. The polarizing panel 240 uses a polarize switch (PS) panel having a function of alternately changing between a P wave and an S wave. This function changes a polarizing direction of the PS switch in synchronization with cycles of image signals corresponding to left-eye and right-eye images displayed on the liquid crystal display panel.

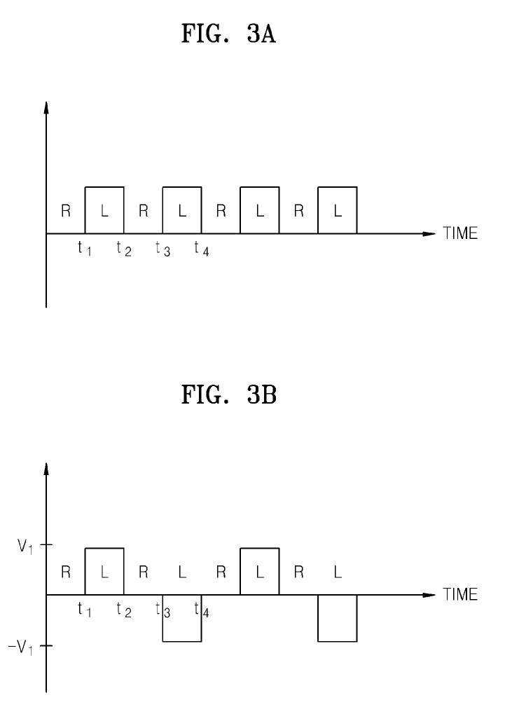

FIGS. 3A and 3B are waveform diagrams of the stereo synchronization signal and the polarizing panel driving signal generated by the stereo synchronization signal generator 210 and the polarizing panel driver 224 illustrated in FIG. 2. Referring to FIG. 3A, the stereo synchronization signal generator 210 illustrated in FIG. 2 generates a periodic square-wave signal. Specifically, the stereo synchronization signal generator 210 illustrated in FIG. 2 generates a synchronization signal value for a left-eye image in a period from t1 to t2 and generates a synchronization signal value for a right-eye image in a period from t2 to t3. Referring to FIG. 3B, the polarizing panel driver 224 illustrated in FIG. 2 applies a driving voltage V1 to the polarizing panel 240 illustrated in FIG. 2 in a period from t1 to t2 such that polarizing direction of the polarizing panel is changed to be suitable for the left-eye image. The polarizing panel driver 224 illustrated in FIG. 2 applies a driving voltage −V1 to the polarizing panel 240 illustrated in FIG. 2 in a period from t3 to t4 such that the polarizing direction of the polarizing panel 240 illustrated in FIG. 2 is changed to be suitable for the left-eye image. The polarizing panel driver 224 illustrated in FIG. 2 applies a driving voltage 0V to the polarizing panel 240 such that polarizing direction of the polarizing panel 224 is changed to be suitable for the right-eye image.

Referring back to FIG. 2, in the 2D mode, only the vertical synchronization signal is supplied from the external device to the 2D/3D convertible display apparatus 200. In principle, the stereo synchronization signal generator 210 does not operate and apply the stereo synchronization signal to the polarizing panel driver 224, and thus the polarizing panel driver 224 does not output the polarizing panel driving signal and the polarizing panel 240 is off However, in the 2D/3D convertible display apparatus according to the current embodiment of the present invention, the vertical synchronization signal is applied to the stereo synchronization signal generator 210 as well as the liquid crystal display panel driver 222, and thus the stereo synchronization signal generator 210 generates the stereo synchronization signal. Accordingly, the polarizing panel driver 224 outputs the polarizing panel driving signal to drive the polarizing panel 240. That is, the polarizing panel is operated even in the 2D mode in the 2D/3D convertible display apparatus according to the present invention.

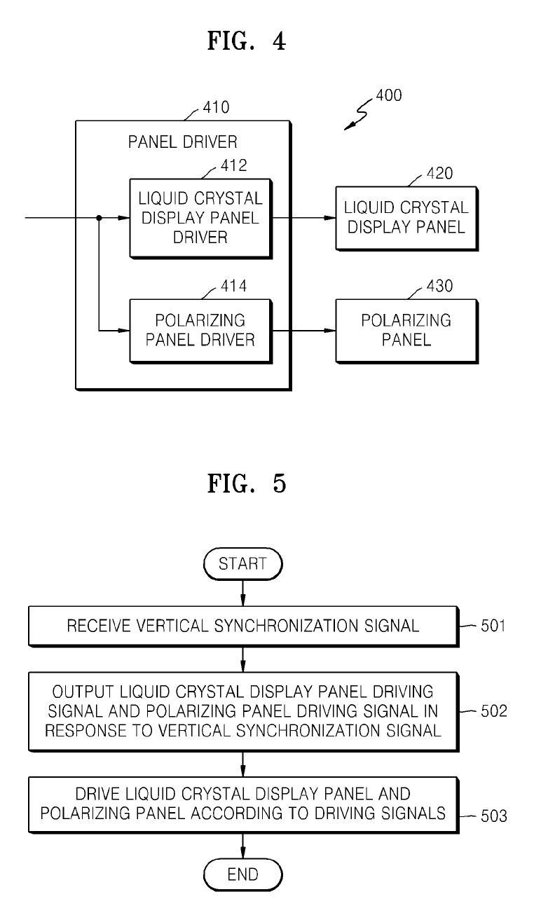

FIG. 4 is a block diagram of a 2D/3D convertible display apparatus 400 according to another embodiment of the present invention. Referring to FIG. 4, the 2D/3D convertible display apparatus 400 applies signals for respectively driving a liquid crystal display panel 420 and a polarizing panel 430. The 2D/3D convertible display apparatus 400 includes a panel driver 410, the liquid crystal display panel 420 and the polarizing panel 430. The panel driver 410 includes a liquid crystal display panel driver 412 and the polarizing panel driver 414. Only the operation of the 2D/3D convertible display apparatus in the 2D mode is explained. In the 2D mode, a vertical synchronization signal is supplied from an external device to the liquid crystal display panel driver 412 and the polarizing panel driver 414. The polarizing panel driver 414 generates a polarizing panel driving signal in response to the vertical synchronization signal and applies the polarizing panel driving signal to the polarizing panel 430.

FIG. 5 is a flow chart of a method of driving a 2D/3D convertible display apparatus according to an embodiment of the present invention. Referring to FIG. 5, only a vertical synchronization signal is received when the 2D/3D convertible display apparatus is in a 2D mode in operation 501. A liquid crystal display panel driving signal and a polarizing panel driving signal are output in response to the vertical synchronization signal in operation 502. The polarizing panel driving signal has the waveform illustrated in FIG. 3B. A liquid crystal display panel and a polarizing panel of the 2D/3D convertible display apparatus are driven according to the liquid crystal display panel driving signal and the polarizing panel driving signal in operation 503.

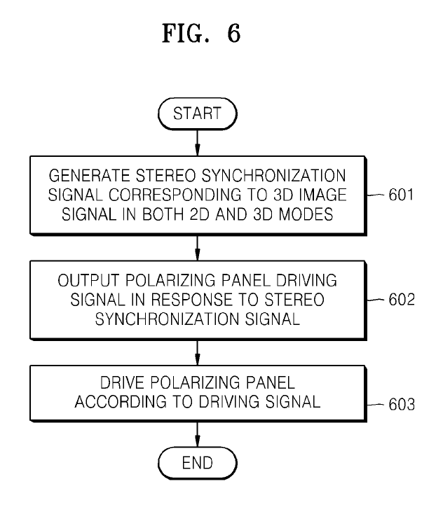

FIG. 6 is a flow chart of a method of driving a 2D/3D convertible display apparatus according to another embodiment of the present invention. Referring to FIG. 6, a stereo synchronization signal corresponding to a 3D image signal is generated in both a 2D mode and a 3D mode in operation 601. In the 2D mode, the stereo synchronization signal is forcibly generated because the stereo synchronization signal is not automatically generated. A polarizing panel driving signal is output in response to the stereo synchronization signal in operation 602. A polarizing panel of the 2D/3D convertible display apparatus is driven according to the polarizing panel driving signal in operation 603.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A 2D/3D convertible display apparatus comprising:
a panel driver which applies a first driving signal to a liquid crystal display panel in response to a vertical synchronization signal and applies a second driving signal to a polarizing panel in response to a stereo synchronization signal, wherein the polarizing panel changes a direction of polarization of an incident light beam according to the second driving signal; and
a synchronization signal generator which generates the stereo synchronization signal to cause the panel driver to apply the second driving signal to the polarizing panel in both 2D and 3D modes.

2. The 2D/3D convertible display apparatus of claim 1, further comprising the liquid crystal display panel.

3. The 2D/3D convertible display apparatus of claim 2, further comprising the polarizing panel.

4. The 2D/3D convertible display apparatus of claim 3, wherein the liquid crystal display panel corresponds to an optically compensated birefringence (OCB) liquid crystal display panel.

5. The 2D/3D convertible display apparatus of claim 3, wherein the panel driver comprises:
a liquid crystal display panel driver which outputs the first driving signal; and
a polarizing panel driver which outputs the second driving signal.

6. A 2D/3D convertible display apparatus comprising:
a panel driver which simultaneously applies a first driving signal to a liquid crystal display panel and a second driving signal to a polarizing panel in response to a vertical synchronization signal, wherein the polarizing panel changes a direction of polarization according to the second driving signal.

7. The 2D/3D convertible display apparatus of claim 6, further comprising the liquid crystal display panel.

8. The 2D/3D convertible display apparatus of claim 7, further comprising the polarizing panel.

9. The 2D/3D convertible display apparatus of claim 8, wherein the liquid crystal display panel corresponds to an optically compensated birefringence (OCB) liquid crystal display panel.

10. The 2D/3D convertible display apparatus of claim 9, wherein the panel driver comprises:
a liquid crystal display panel driver which outputs the first driving signal; and
a polarizing panel driver which outputs the second driving signal.

11. A method of driving a 2D/3D convertible display apparatus, comprising:
receiving a vertical synchronization signal in 2D mode;
outputting a liquid crystal display panel driving signal and a polarizing panel driving signal in response to the vertical synchronization signal; and
driving a liquid crystal display panel and a polarizing panel according to the liquid crystal display panel driving signal and the polarizing panel driving signal.

12. A method of driving a 2D/3D convertible display apparatus, comprising:
generating a stereo synchronization signal in both 2D and 3D modes;
outputting a polarizing panel driving signal in response to the stereo synchronization signal; and
driving a polarizing panel according to the polarizing panel driving signal.
